(19) United States
(12) Patent Application Publication
(10) Pub. No.: US 2026/0171457 A1
(43) Pub. Date: Jun. 18, 2026

(54) PRESSURISED ELECTROCHEMICAL REACTOR

(71) Applicant: COMMISSARIAT A L'ENERGIE ATOMIQUE ET AUX ENERGIES ALTERNATIVES, Paris (FR)

(72) Inventor: Karl VULLIEZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/421,573

(22) Filed: Dec. 16, 2025

(30) Foreign Application Priority Data
Dec. 16, 2024 (FR) FR2414243

(51) Int. Cl. H01M 8/248; H01M 8/04007; H01M 8/2404; H01M 8/2475

(52) U.S. Cl. CPC H01M 8/248; H01M 8/04007; H01M 8/2404; H01M 8/2475

(57) ABSTRACT

An electrochemical reactor, configured to receive a stack, the reactor including a support plate, the stack being positioned in contact with the support plate, wherein the reactor further includes a dome, having an internal volume (Vᵢₙₜ), intended to receive the stack, of the liquid glass frit having a volume (Vₗ) and an upper face called free surface, and configured to cover the stack, the internal volume further including a cover gas positioned in contact with the free surface of the liquid frit volume, the cover gas being configured to be pressurised by a module at a clamping pressure (Ps), this being configured so as to maintain the stack compressed on the support plate, under a mechanical force proportional to the clamping pressure.

### TECHNICAL FIELD

The present invention relates to the field of solid oxide fuel cells (SOFC) and that of high temperature water electrolysis, also solid oxide water electrolysis (SOEC-solid oxide electrolysis cells). More specifically, the invention relates to maintaining a stack used in SOFC- and SOEC-type fuel cells.

### PRIOR ART

Systems for producing gas and/or electricity by solid oxide fuel cell fall under two large technological areas: tubular systems and planar systems. In the scope of planar technologies, SOEC (solid oxide electrolysis cell) systems or SOFC (solid oxide fuel cell) systems are constituted of an alternated stack of an active part, the electrochemical cell, typically made of ceramic, and of metal bipolar plates.

The stack thus comprises a plurality of thin interconnecting plates mounted between two rigid end plates, which are subjected to a voltage differential. In order to ensure the electrical continuity of numerous stages of these structures and the powering of each of the cells mounted in series in the stack, it is necessary to exert a compression force on the stack, in order to initiate and maintain bearing the contact zones. A compression defect, limiting the passage of the current in the multilayer structure is conveyed by an increase of ohmic losses in the stack and with heatings. In operation, guaranteeing a good compression of the stack is an essential prerequisite to ensure its good operation.

In current industrial designs, the modules grouping together several stacks mounted in one same heating chamber are generally clamped by external mechanical devices, capable of maintaining a quasi-constant compression force, by accommodating thermal dilations of the components.

These external mechanical devices can be secured to the stack. Self-clamping mounting is referred to, and they make it possible to maintain the stack compressed between two thick flanges connected by threaded tie rods. The self-clamping mountings however show technical limits for large stacks.

These external mechanical devices can also be offboard. The stack is thus mounted on a rigid base bearing on the furnace hearth of the heating chamber and is compressed by a crossmember born by an external device. The external clamping devices have numerous disadvantages in terms of integration, in particular when it has proved to be necessary to offboard them outside of the heat chambers.

In addition, the external devices maintaining a constant force must, in order to accommodate the geometric variations during thermal cycles, integrate elastic elements. It is difficult to integrate these elastic elements inside heating chambers. The latter must therefore be made of special alloys, compatible with the operating conditions of the stacks. Thus, the application of a compression force on a stack or on a module comprising a plurality of stacks positioned in a heating chamber is, due to high temperatures of use, technically very complex.

An aim of the invention is to propose a solution making it possible to simplify the application of this compression force on a stack positioned in a heating chamber.

Other aims can be achieved by this solution.

### SUMMARY

To achieve this aim, according to an embodiment, an electrochemical reactor is provided, configured to receive a stack having a first face and a second face opposite the first face, and at least one external wall connecting the first face to the second face, and configured to operate at an operating temperature, the reactor comprising:
a support configured to ensure the passage of supply gases for the stack, the support comprising a support plate, the stack being positioned so as to have its second face in contact with the support plate,
   characterised in that the reactor further comprises:
a closing dome, having an internal volume, intended to receive the stack and to be hermetically fixed on the support,
the glass frit having a glass frit volume and positioned in the internal volume, and configured to perform a phase transition at the operating temperature of the stack, so as to form the liquid glass frit having a liquid glass frit volume and further configured to cover the stack, the liquid glass frit volume less than the internal volume, and having an upper face called free surface,
   the internal volume further comprising a so-called cover gas, the cover gas being positioned above and in contact with the free surface of the liquid frit volume, the cover gas being configured to be pressurised at a clamping pressure by a pressurising module, the clamping pressure being configured, so as to maintain the stack compressed on the support plate under a mechanical force proportional to the clamping pressure.

Thus, the invention makes it possible to maintain, by hydrostatic effect, the pressure exerted on the free face of the glass and is fully transmitted homogeneously onto the end plate of the stack, and this, without the necessity of mechanical components.

Advantageously, the compression force which is transmitted to the stack is adjustable by making the internal pressure vary. The proposed device thus constitutes an active system making it possible to continuously adjust the compression force according to the internal pressure of the stack.

In addition, another advantage of the design is to ensure a very high sealing of the stack. Indeed, external walls of the stack, the interface of the stack with its manifold support plate and the interface between the dome and the support plate are in the glass bath, also, there are no longer gas sealings which must be ensured by seals and sealants, but a sealing at the glass (a viscous liquid). The only gas sealing ensured is that of the stopper welded on the dome. In terms of leakage at the stack, the supply gases being at a pressure less than that of the external fluid, they can no longer exit, as subjected to a counterpressure. The crack-type defects in the sealants, which can be responsible in a stack for gas leaks, have geometries (micrometric dimensions, high tortuosity, capillarity effect, very high viscosity) which do not enable the passage of a viscous fluid such as glass.

According to another aspect, a method for pressurising an electrochemical reactor is provided, such as described above, in which the method comprises:
a positioning of the stack on the support,
a positioning and a fixing of the dome on the support, so as to surround the stack,
a filling of the dome with the glass frit through an opening,
a fixing of a stopper in the opening, so as to make the internal volume of the hermetic dome,
an increasing of the temperature in the reactor, so as to reach the operating temperature,
a pressurising of the reactor up to a clamping pressure by the pressurising module.

Thus, the implementation of this compression is facilitated and rapid to implement.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIGS. 1A and 1B represent a support according to an embodiment of the invention.

FIGS. 2A and 2B represent a dome according to an embodiment of the invention.

FIGS. 3A and 3B represent the stack positioned on the support according to an embodiment of the invention.

FIGS. 4A and 4B represent the closing of the dome on the support according to an embodiment of the invention.

FIGS. 5A to 5D represent the insertion of the glass frit and the pressurising of the device according to an embodiment of the invention.

FIGS. 6A and 6B represent another embodiment of the invention.

The drawings are given as examples, and are not limiting of the invention. They constitute principle schematic representations, intended to facilitate the understanding of the invention, and are not necessarily to the scale of practical applications.

### DETAILED DESCRIPTION

Before starting a detailed review of embodiments of the invention, optional features are stated below, which can optionally be used in association or alternatively:

According to an example, the clamping pressure is between 500 hPa and 200 kPa. These low pressure values of pressure Ps, make it possible to consider the production of a pressurised chamber operating at a high temperature compatible both with the sealing interfaces, and with thermomechanical stresses. This clamping pressure thus makes it possible to homogeneously transmit a sufficient pressure to maintain the pressure exerted on the stack, by hydrostatic effect.

According to an example, the liquid glass frit volume covers at least the first face and at least one external wall of the stack, so as to generate a counterpressure. This makes it possible to maintain a pressure on the assembly of the stack, without additional mechanical means. This also makes it possible to ensure a second barrier and protect the at least one external wall of the stack, in case of a localised hydrogen leak.

According to an example, the dome has a structure configured, so as to be adapted to the architecture of the stack. The dome thus makes it possible to ensure to correctly cover the stack, and thus ensure the presence of a sufficient internal volume to ensure a frit volume, making it possible to maintain it by hydrostatic effect.

According to an example, the dome has, at least on one portion, a curved internal surface. The curved internal surface thus makes it possible to resist the internal pressure when the cover gas is pressurised, and thus resists a sufficient pressure to maintain the stack compressed.

According to an example, the dome and the support are metal parts. Thus, the assembly of the elements makes it possible to resist high temperatures and pressures used in the scope of the invention.

According to an example, the dome has an opening on an upper part of the dome, and a closing stopper, intended to engage complementarily with the opening, the opening has a dimension typically between 1 and 5 cm, so as to enable the insertion of the glass frit. The opening is thus quite large to enable an easy insertion of the glass frit, but small enough to facilitate the mounting of a stopper or of a connector.

According to an example, the reactor comprising a clamping device, the clamping device comprising a support ring positioned on the first face of the stack and mechanical connections, the mechanical connections being configured, so as to connect and secure the support ring to the support plate. The clamping device thus makes it possible to maintain the stack in contact with the cold support plate, i.e. before the operation of the reactor. The mechanical maintenance does not however enable an optimal maintenance and it is necessary to apply an additional maintenance such as described in the invention by hydrostatic effect to maintain the stack when the reactor is put into operation.

According to an example, the clamping device comprises an insulating ring, the insulating ring being positioned between the support ring and the first face of the stack. The insulating ring thus makes it possible to avoid the electrical connections between the top of the stack and the support plate, which is a manifold plate via the mechanical connections. Thus, this avoids an incorrect operation of the reactor.

According to an example, the dome comprises a support flange configured to fix the dome to the support, the reactor further comprising an insulating spacer positioned between the support flange and the support plate of the support. With the soaking glass of the stack not being fully insulating, this spacer makes it possible to limit the parasitic current leaks created by a polarisation of the dome.

According to an example, the dome, the insulating spacer and the support plate are configured, so as to be fixed together in contact by a mechanical device comprising at least one through clamping screw. The mechanical device thus makes it possible to flatten the dome on the support, in order to ensure the compression of seals placed between each of the interfaces. The mechanical device thus makes it possible to ensure a sealing of the internal volume comprising the liquid glass and the stack, and thus ensures a correct operation of the compression of the stack during the pressure increase.

According to an example, the mechanical device comprises at least one insulating sleeve, the at least one insulating sleeve being configured to insulate the at least one through clamping screw. The at least one insulating sleeve thus makes it possible to limit the current losses.

According to an example, the operating temperature is greater than 650° C. The elements of the reactor can thus resist the operating temperatures of the stack. Additionally, this makes it possible to ensure that a glass bath is correctly created around the stack, in order to ensure a homogeneous pressure during the operation of the reactor.

According to an example, the reactor comprises heating blocks, the heating blocks being positioned in contact with an external surface of the dome. The heating blocks thus make it possible to form a glass bath surrounding the stack as close as possible, with heating devices also located very close to these external walls. The glass bath is thus created rapidly and makes it possible to ensure a homogenous bath enabling the application of a force by homogeneous hydrostatic effect.

According to an example, the reactor comprises a stack, the stack comprising:
an upper plate having a first upper face, the first upper face being configured to be the first face of the stack,
a superimposition of at least one electrochemical cell and of at least one bipolar plate, positioned along a stacking direction E,
a lower plate having a second lower face, the second lower face being configured to be the second face of the stack.

According to an example, the support is made of a material identical to the material of the upper plate and of the lower plate. Thus, the production of these elements in one same material makes it possible to limit the thermomechanical stresses due to the thermal dilations on the sealings mounted at the interfaces.

According to an example, the upper plate and the lower plate can be made of different materials and have a close thermal expansion coefficient. Thus, this makes it possible to limit the thermomechanical stresses due to the thermal dilations on the sealings mounted at the interfaces.

It is specified that, in the scope of the present invention, the terms “on”, “surmounts”, “covers”, “underlying”, “opposite” and their equivalents, do not necessarily mean “in contact with”. Thus, for example, the deposition, the transfer, the bonding, the assembly or the application of a first element on a second element does not compulsorily mean that the two elements are directly in contact with one another, but means that the first element covers, at least partially, the second element, by being either directly in contact with it, or by being separated from it by at least one other element. These elements can, for example, be layers.

A layer can moreover be composed of several sublayers of one same material or of different materials.

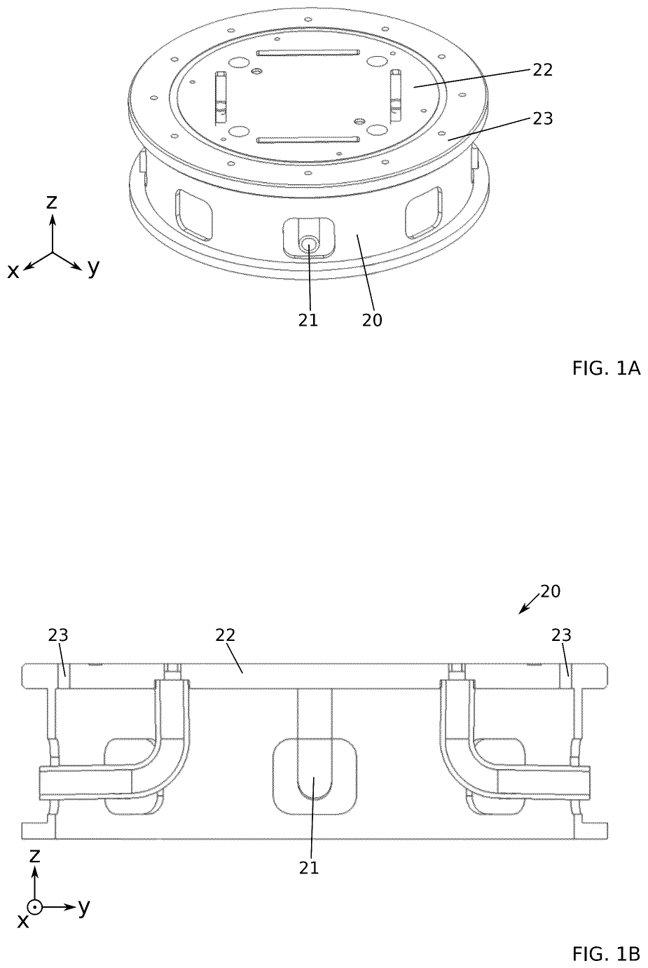

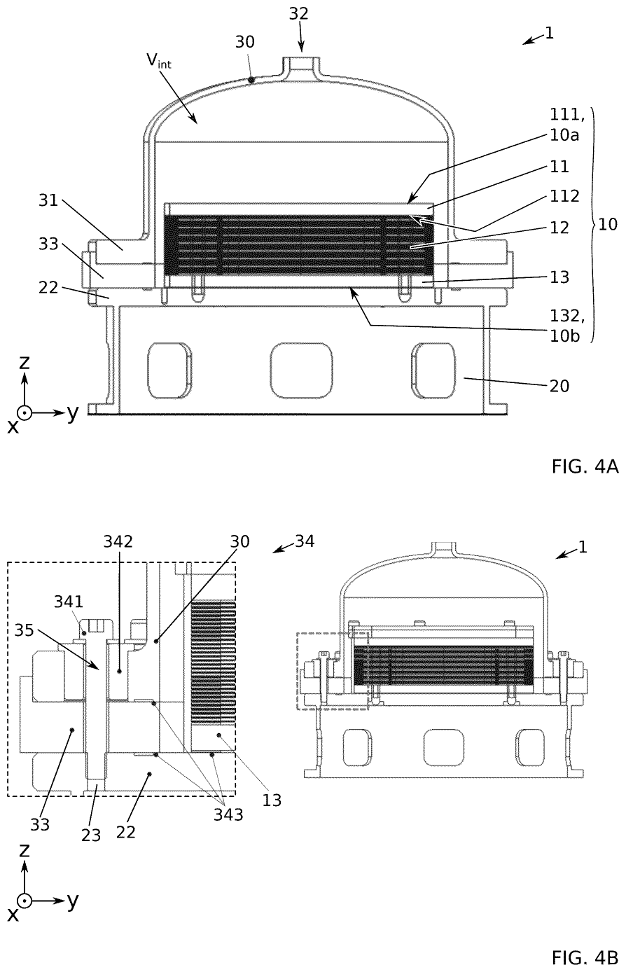

A preferably orthonormal system, comprising the axes X, Y, Z is represented in FIGS. 1A to 6B.

The terms “substantially”, “around”, “about” mean “plus or minus 10%, preferably plus or minus 5%”.

In the detailed description below, use can be made of terms such as “horizontal”, “vertical”, “longitudinal”, “transverse”, “top”, “bottom”, “upper”, “lower”. These terms must be interpreted relatively, in relation to the normal position of the assembly of the electrochemical reactor, and the normal direction of position on a plane of it.

The present invention relates to an electrochemical reactor 1. The chemical reactor 1 will now be described in reference to FIGS. 1A to 6B.

The electrochemical reactor 1 is configured to receive a stack 10. The stack 10 has a first face 10a and a second face 10b. The second face 10b is opposite the first face 10a. The first face 10a and the second face 10b can advantageously extend into a plane (XY). The stack 10 also has at least one external wall. The at least one external wall of the stack 10 advantageously connects the first face 10a to the second face 10b. The stack 10 is configured to operate at a temperature called operating temperature Top. The stack 10 can thus be placed in a heating chamber or otherwise called the electrochemical reactor 1.

The electrochemical reactor 1 comprises a support 20. An example of a support 20 is illustrated in FIG. 1A and in FIG. 1B. The support 20 is configured to ensure the passage of supply gases 21 of the stack 10. The passage of supply gases 21 can be ensured by pipes. Advantageously, the support 20 can thus have four pipes, two pipes being configured to ensure the entry of the supply gases into the stack 10 and two pipes being configured to ensure the exit of the supply gases from the stack 10.

The support 20 comprises a support plate 22. Advantageously, the stack 10 is positioned so as to have its second face 10 in contact with the support plate 22. The support 20 and more specifically the support plate 22 can act as a base of the stack 10. The support plate 22 can also serve as a manifold plate.

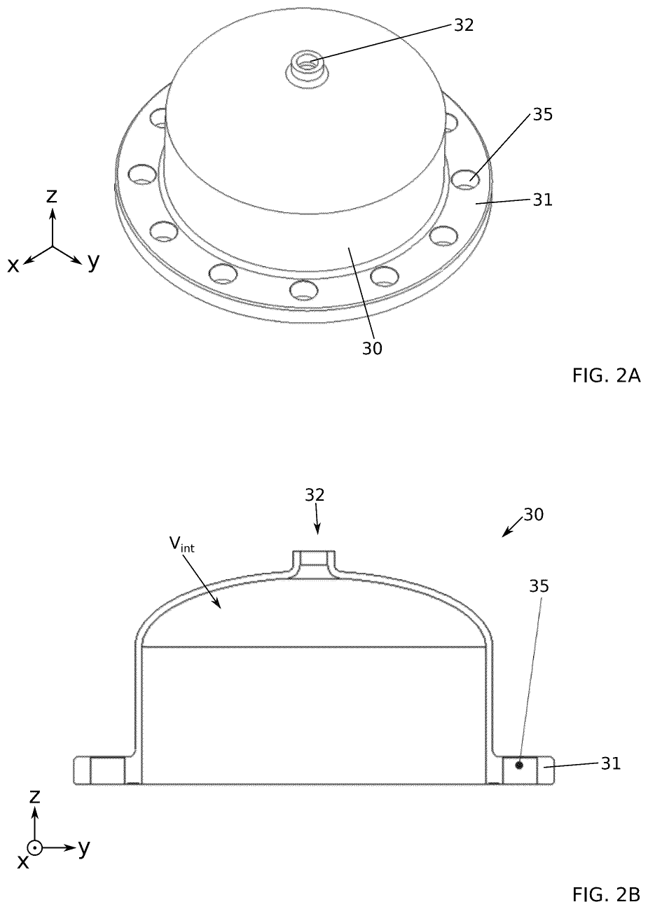

The electrochemical reactor 1 further comprises a closing dome 30. The closing dome will now be described in reference to FIG. 2A and to FIG. 2B.

The closing dome 30 has an internal volume Vᵢₙₜ. The closing dome 30 and therefore the internal volume Vᵢₙₜ is intended to receive the stack 10. The closing dome 30 is also intended to be hermetically fixed on the support 20. Preferably, at least one part of the closing dome 30 is positioned in contact with the support plate 22.

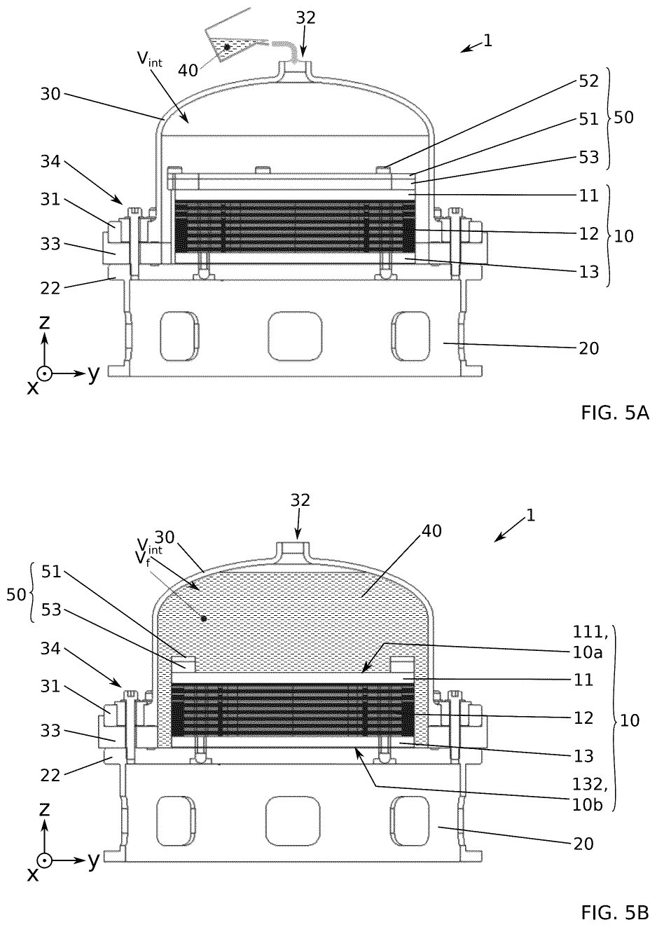

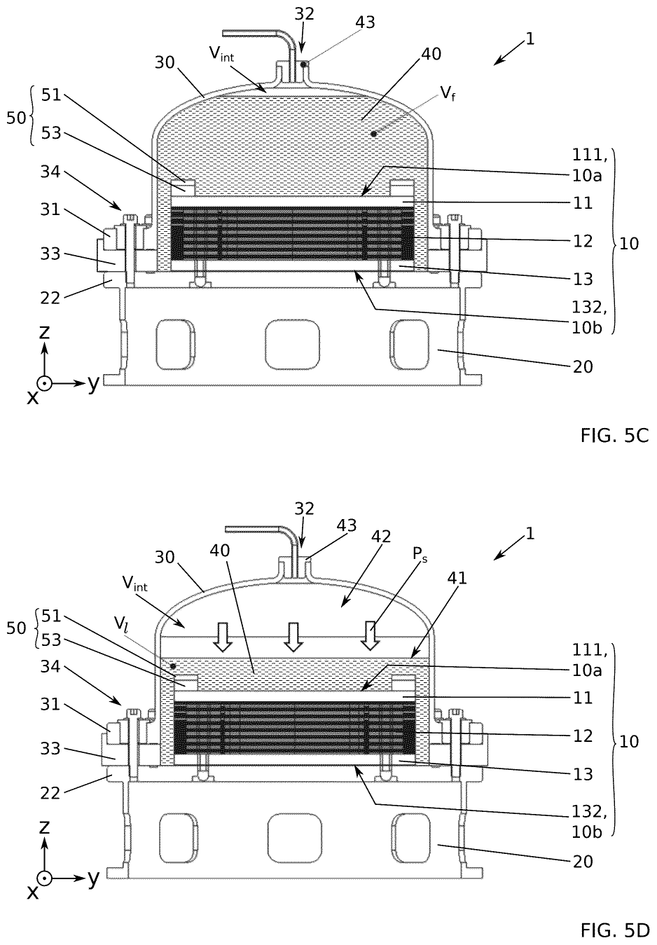

The electrochemical reactor 1 also comprises the glass frit 40. The glass frit 40 has a volume V_{f}. The glass frit 40 volume V_{f} is positioned in the internal volume Vᵢₙₜ of the closing dome 30. The glass frit 40 is configured to perform a phase transition when the electrochemical reactor 1 reaches the operating temperature Tₒₚ. The phase transition makes it possible for the glass frit 40 to pass from a solid form (illustrated, for example, in FIG. 5B) to a liquid form (illustrated, for example, in FIG. 5D). The liquid glass frit 40 thus has a volume Vₗ, the liquid frit volume Vₗ is thus less than the internal volume Vᵢₙₜ of the closing dome 30. In addition, the liquid glass frit 40 covers the stack 10. The liquid glass frit 40 covers the stack 10, so as to cover the first face 10a of the stack 10. Preferably, the liquid glass frit 40 totally covers the stack 10. The liquid glass frit 40 also has an upper face called free surface 41.

The internal volume Vᵢₙₜ of the closing dome 30 further comprises a gas called cover gas 42. The cover gas 42 is positioned above the free surface 41. More specifically, the cover gas 42 is in contact with the free surface 41 of the liquid frit volume Vₗ. The cover gas 42 is thus configured to be pressurised. The pressurising can be done by a pressurising module. The pressurising module can be, for example, an injection system linked to a compressor positioned outside of the electrochemical reactor 1.

The cover gas 42 is pressurised at a clamping pressure Pₛ. The clamping pressure Pₛ is configured, so as to maintain the stack 10 compressed on the support plate 22 under a mechanical force proportional to the clamping pressure Pₛ. Indeed, the pressurising of the cover gas 42 enables the application of a compression force without implementing mechanical devices on the stack 10 transmitted by the liquid glass frit 40.

The balance of forces in the mechanical assembly, outside of gravity, is as follows: a force applied internally by a pressure of the supply gases 21 of the stack 10 which is equal to a mean pressure of the supply gases 21 multiplied by an internal surface of the stack 10 on which it is applied, the force applied by the cover gas 42 on the stack 10 which is equal to the pressure Pₛ of the cover gas 42 maintained in the closing dome 30 multiplied by a surface of the first face 10a of the stack 10.

With a clamping pressure Pₛ of cover gas 42 greater than the pressure of the supply gases 21 coupled to a surface of the first face 10a of the stack 10 greater than an internal surface of the stack 10, a compression force is generated on the first face 10 of the stack 10 transmitted by the liquid glass frit 40.

The clamping pressure Pₛ to be applied depends on the dimensions of the stack 10 and on the pressure of the supply gases 21. According to an example, the clamping pressure Pₛ is between 500 hPa (hectopascal) and 200 kPa (kilopascal). For example, with a first face 10a of the stack 10, which has a diameter of 112.5 mm (millimetres), the pressure necessary for generating the compression force is around 500 hPa. These low pressure values of pressure Pₛ, make it possible to consider the production of a pressurised chamber operating at a high temperature, compatible both with sealing interfaces, and with thermomechanical stresses. The thermomechanical stresses being limited for a high-temperature use.

The liquid glass frit 40 thus enables a uniform transmission on the assembly of the stack 10 of the compression force. The liquid glass frit 40 further makes it possible to avoid gas leaks coming from the stack 10. Indeed, according to an example, the liquid glass frit 40 volume VI covers at least the first face 10a and the at least one external wall of the stack 10, so as to generate a counterpressure. This thus makes it possible to ensure a second barrier and protect the at least one external wall of the stack 10, in case of a localised hydrogen leak. The compression of the glass frit 40 guarantees, in addition, a better sealing by generating a counterpressure prohibiting the bubbling of runaway gases in the glass matrix.

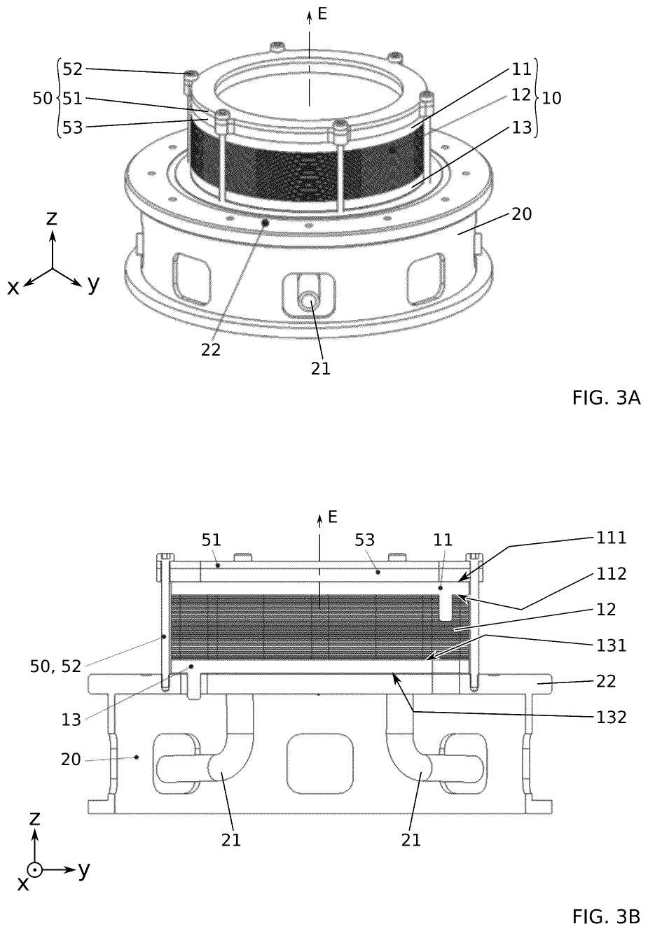

As explained above, the reactor 1 is configured to receive a stack 10. The stack 10 is positioned on the support plate 22 of the support 20. A possible stack 10 is represented in FIGS. 3A and 3B, and will now be described.

According to an example, the stack 10 comprises an upper plate 11. The upper plate 11 can have a first face 111. The first face 111 of the upper plate 11 can be assimilated to the first face 10a of the stack 10. The stack 10 can also comprise a lower plate 13. The lower plate 13 has a second face 132. The second face 132 can be assimilated to the second face 10b of the stack 10. Between the upper plate 11 and the lower plate 13, the stack 10 can comprise a superimposition 12 of at least one electrochemical cell and of at least one bipolar plate. Advantageously, the lower plate 13, the superimposition 12 and the upper plate 11 are superimposed to one another along a stacking direction E. According to an example, the electrochemical reactor 1 comprises a stack 10 such as described above.

The upper plate 11 and the lower plate 13 can advantageously be made of one same material. In addition, the support 20 and more specifically the support plate 22 can be made of a material identical to the material of the upper plate 11 and of the lower plate 13. At least one portion of the support plate 22 and the upper 11 and lower 13 plates will be subjected to high temperatures during the operation of the electrochemical reactor 1. Thus, the production of these elements in one same material makes it possible to limit the thermomechanical stresses due to the thermal dilations on the sealings mounted at the interfaces.

The upper plate 11 and the lower plate 13 can advantageously be made of different materials, and having a close thermal expansion coefficient. By close thermal coefficient, this means a coefficient having a difference against one another not exceeding a difference of plus or minus 10⁻⁶° C.⁻¹. Thus, this makes it possible to limit the thermomechanical stresses due to the thermal dilations on the sealings mounted at the interfaces.

According to an example, the electrochemical reactor 1 comprises a clamping device 50. The clamping device 50 is configured to maintain the compression of the cold stack 10. Thus, the clamping device 50 can be positioned, so as to apply a pressure in the direction of the support 20 on the first face 10a of the stack 10.

The clamping device 50 can thus comprise a support ring 51. The support ring 51 is thus configured to be positioned on the first face 10a of the stack 10. Similarly, the support ring 51 is positioned on the first upper face 111 of the upper plate 11 of the stack 10. Advantageously, the support ring 51 does not totally cover the surface of the first face 10a of the stack 10. The support ring 51 can thus be positioned on a periphery of the first face 10a of the stack 10.

The clamping device 50 can also comprise mechanical connections 52. The mechanical connections 52 are configured, so as to connect the support ring 51 to the support plate 22. More specifically, the mechanical connections 52 are configured to secure the support ring 51 to the support plate 22. The mechanical connections 52 thus make it possible to ensure a contact between the second face 10b of the stack 10 and the support plate 22, when the reactor 1 is cold. The mechanical connections 52 can, for example, be compression tie rods. The mechanical connections 52 are thus positioned on a periphery of the stack 10. The clamping device 50 has at least two mechanical connections 52. The at least two mechanical connections 52 are positioned, so as to have at least one symmetry on the stacking axis E. Thus, the compression force applied is homogeneous on the assembly of the stack 10.

Advantageously, the clamping device 50 also comprises an insulating ring 53. The insulating ring 53 is thus positioned between the support ring 51 and the first face 10a of the stack 10. The insulating ring 53 thus makes it possible to avoid the electrical connections between the top of the stack 10 and the support plate 22, which is a manifold plate via the mechanical connections 52. Just like the support ring 51, the insulating ring 53 is positioned on a periphery of the first face 10a of the stack 10. Preferably, the insulating ring 53 and the support ring 51 has the same dimensions.

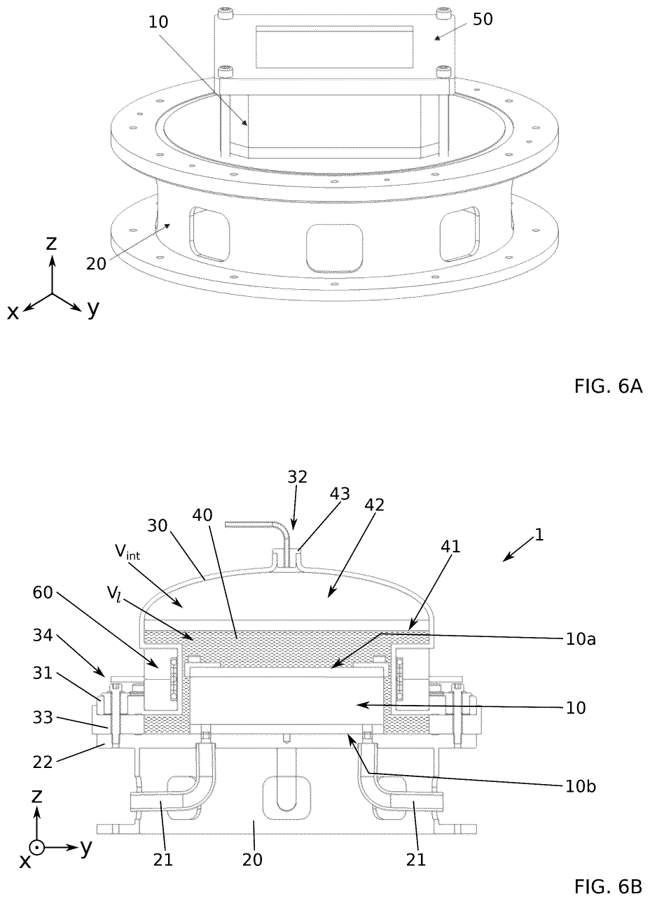

The stack 10 can have a cylindrical or parallelepiped shape. FIGS. 3A to 5D represent, in a non-limiting manner, a cylindrical stack 10. FIGS. 6A and 6B represent, in a non-limiting manner, a parallelepiped stack 10. Due to this, in order to ensure a correct operation, the closing dome 30 must be adapted to the shape of the stack 10. The closing dome 30 can thus have a structure configured so as to be adapted to the architecture of the stack 10.

Once the stack 10 is assembled and/or positioned on the support 20, the dome 30 can be implemented above the stack 10.

The dome 30 can advantageously comprise, a support flange 31. The support flange 31 is configured to fix the dome 30 to the support 22. More specifically, the support flange 31 comprises a plurality of holes 35 (illustrated in FIG. 2A). The holes 35 are thus configured to align with openings 23 (illustrated in FIG. 1A) present on the support plate 22 of the support 20. The support flange 31 is thus positioned facing the support plate 22.

The reactor 1 can further comprise an insulating spacer 33 positioned between the support flange 31 and the support plate 22 of the support 20. The insulating spacer 33 advantageously extends only between the support flange 31 and the support plate 22. With the soaking glass of the stack 10 not being fully insulating, this spacer 33 makes it possible to limit the parasitic current losses created by a polarisation of the dome 30.

Thus, the dome 30, the insulating spacer 33 and the support plate 22 can be configured, so as to be fixed together in contact by a mechanical device 34. The mechanical device 34 thus makes it possible to flatten the dome 30 on the support 20, in order to ensure the compression of seals 343 placed between each of the interfaces. The mechanical device 34 can thus comprise at least one through clamping screw 341. The at least one through clamping screw 341 is configured to pass through at least one hole 35 and to be inserted into an opening 23 of the support 20. The at least one opening 23 can thus have a screw thread, so as to enable the screwing of the through clamping screw 341. The mechanical device 34 comprises as many through clamping screws 341 as there are holes 35 in the support flange 31.

Preferably, the mechanical device 34 also comprises at least one insulating sleeve 342. The at least one insulating sleeve 342 is thus configured to insulate the at least one through clamping screw 341. The at least one insulating sleeve 342 thus makes it possible to limit the current losses. Thus, the mechanical device 34 comprises as many insulating sleeves 342 as it comprises through clamping screws 341.

Additionally, the closing dome 30 can have at least one curved internal surface on an upper part. The curved internal surface thus makes it possible to resist the internal pressure when the cover gas 42 is pressurised. By curved internal surface, this means a convex internal surface.

Likewise, the dome 30 can have an opening 32 on this upper part. The opening 32 is configured to enable the insertion of the glass frit 40 in the reactor 1 once the dome 30 is fixed on the support 20. To do this, the opening 32 has a dimension typically between 1 and 5 cm. The opening 32 is thus quite large to enable an easy insertion of the glass frit 40, but small enough to facilitate the mounting of a stopper or of a connector.

According to an example, the dome 30 can have a closing stopper 43. The stopper 43 is, for example, represented in FIGS. 5C and 5D. The stopper 43 is intended to engage complementarily with the opening 32. The stopper 43 thus makes it possible to close the dome 30, and thus make the internal volume Vᵢₙₜ hermetic. The stopper 43 is thus configured to ensure a sealing to pressurised gases. The stopper 43 is advantageously fixed to the opening 32 by welding or by a seal, for example, by a metal seal. The stopper 43 is thus sealingly fixed on the dome 30. The closing stopper 43 can advantageously have a pipe. The pipe can thus be configured to enable the production of a tap configured to insert the cover gas 42. The pipe can thus be comprised in the pressurising module. The cover gas 42 inserted by the pipe can thus be pressurised.

According to an example, the assembly of the elements is configured, so as to resist high temperatures and pressures such as described above. Advantageously, the dome 30 is thus a metal part. More specifically, the dome 30 is made of an alloy compatible with a high-temperature use. Likewise, the support 20 is also a metal part. The support 20 is therefore also made of an alloy compatible with a high-temperature use. By high temperature, this means, for example, temperatures of between 600° C. and 900° C.

According to an example, the operating temperature Tₒₚ is greater than 650° C. Preferably, the operating temperature Tₒₚ is less than 900° C. The elements of the reactor 1 can thus resist the operating temperatures of the stack 10. In addition, the formulation of the glass frit 40 is chosen, such that the temperature of the melting point of the glass is less than the operating temperature Tₒₚ of the stack 10. The formation of the glass 40 also ensures a vitreous, viscous glass bath, lightly crystalised or non-crystallised. During the initial melting of the frit 40, the volume of the glass Vₗ decreases (between 30 and 50%). In order to guarantee that once melted, the glass matrix completely covers the stack, the volume Vᵢₙₜ of the dome must be sized to be able to be filled with a sufficient volume V_{f} of glass frit 40.

Thus, during the operation of the reactor 1, it is ensured that the glass 40 is in a liquid form, and therefore ensures a compression force on the stack 10 with the pressurised cover gas. Once the stack 10 is completely immersed by the liquid glass, the pressurising of the cover gas 42 thus makes it possible to compress, under a mechanical force proportional to the clamping pressure Pₛ. By hydrostatic effect, the pressure Pₛ exerted on the free face 41 of the liquid glass is totally and fully homogeneously transmitted onto the upper plate 11 of the stack 10 and this, without requiring mechanical components, like force distributors or support rods/plates. The compression force which is transmitted to the stack 10 is adjustable very easily by making the clamping pressure Pₛ vary. The proposed device thus constitutes an active system, making it possible to continuously adjust the compression force according to the internal pressure of the stack 10.

According to an example illustrated in FIGS. 6A and 6B, the reactor 1 comprises heating blocks 60. The heating blocks 60 can thus be positioned in contact with an external surface of the dome 30. The heating blocks 60 thus make it possible to form a glass bath surrounding the stack 10 as close as possible with heating devices located also very close to these external walls.

The pressurising method of the electrochemical reactor 1 can thus comprise the following steps.

The method can comprise a positioning of the stack 10 on the support 20.

The method can then comprise a positioning of the dome 30 on the support 20. The dome 30 is thus positioned, so as to surround the stack 10. The dome 30 is then fixed to the support 20. It can be fixed via a positioning of the mechanical clamping device 34.

The method then comprises a filling of the dome 30 with a glass frit 40 volume V_{f}. The filling is thus done by inserting the glass frit 40 through the opening 32 located on an upper part of the dome.

The method then comprises a fixing of a stopper 43 in the opening 32. This fixing can be done by welding or via a seal. This fixing is configured to make the internal volume Vᵢₙₜ of the dome 30 hermetic.

The method then comprises an increase of the temperature in the reactor 1, so as to reach the operating temperature Tₒₚ. This step leads to the melting of the frit 40 which becomes a liquid vitreous glass bath having a volume Vₗ at the operating temperature.

Finally, the method comprises a pressurising of the reactor 1 up to a clamping pressure Pₛ. This pressurising is done by a pressurising module. The module can comprise a compressor connected to a pipe present in the stopper 43. The pressurising module can thus directly insert the cover gas 42 in the internal volume of the pressurised dome 30.

The invention is not limited to the embodiments described above, and extends to all the embodiments covered by the invention.

### NUMERICAL REFERENCES

1: electrochemical reactor
10: stack
10a: first face
10b: second face
11: upper plate
111: first upper face
112: second upper face
12: alternance of electrochemical cells and bipolar plates
13: lower plate
131: first lower face
132: second lower face
20: support
21: supply gas
22: support plate
23: openings
30: closing dome
31: support flange
32: opening
33: insulating spacer
34: mechanical clamping device
341: clamping screw
342: insulating sleeves
343: seals
35: holes
40: glass frit
41: free face of the liquid glass frit volume
42: cover gas
43: closing stopper
50: clamping device
51: support ring
52: mechanical connection (compression tie rods)
53: insulating ring
60: heating blocks
Tₒₚ: operating temperature of the stack
E: stacking direction
Vᵢₙₜ: dome internal volume
V_{f}: glass frit volume
Vₗ: liquid glass frit volume
Pₛ: clamping pressure

1. An electrochemical reactor configured to receive a stack having a first face and a second face opposite the first face and at least one external wall connecting the first face to the second face and configured to operate at an operating temperature (Tₒₚ), the electrochemical reactor comprising:
a support configured to ensure the passage of the supply gases of the stack, the support comprising a support plate, the stack being positioned, so as to have its second face in contact with the support plate,
wherein the electrochemical reactor further comprises:
a closing dome, having an internal volume (Vᵢₙₜ), intended to receive the stack and to be hermetically fixed on the support,
the glass frit having a glass frit volume (V_{f}) and positioned in the internal volume (Vᵢₙₜ), and configured to perform a phase transition at the operating temperature (Tₒₚ) of the stack, so as to form the liquid glass frit having a liquid glass frit volume (Vₗ), and further configured to cover the stack, the liquid glass frit volume (Vₗ) being less than the internal volume (Vᵢₙₜ) and having an upper face called free surface,
the internal volume (Vᵢₙₜ) further comprising a gas, called cover gas the cover gas being positioned above and in contact with the free surface of the liquid frit volume (Vₗ), the cover gas being configured to be pressurised at a clamping pressure (Pₛ) by a pressurised module, the clamping pressure (Pₛ) being configured, so as to maintain the stack compressed on the support plate under a mechanical force proportional to the clamping pressure (Pₛ).

2. The electrochemical reactor according to claim 1, wherein the clamping pressure (Pₛ) is between 500 hPa and 200 kPa.

3. The electrochemical reactor according to claim 1, wherein the liquid glass frit volume (Vₗ) covers at least the first face and the at least one external wall of the stack, so as to generate a counterpressure.

4. The electrochemical reactor according to claim 1, wherein the dome has a structure configured, so as to be adapted to the architecture of the stack.

5. The electrochemical reactor according to claim 1, wherein the dome has, at least on a portion, a curved internal surface.

6. The electrochemical reactor according to claim 1, wherein the dome and the support are metal parts.

7. The electrochemical reactor according to claim 1, wherein the dome has an opening on an upper part of the dome, and a closing stopper intended to engage complementarily with the opening, the opening has a dimension typically of between 1 and 5 cm, so as to enable the insertion of the glass frit.

8. The electrochemical reactor according to claim 1, comprising a clamping device, the clamping device comprising a support ring positioned on the first face of the stack and mechanical connections, the mechanical connections being configured, so as to connect and secure the support ring to the support plate.

9. The electrochemical reactor according to claim 8, wherein the clamping device comprises an insulating ring, the insulating ring being positioned between the support ring and the first face of the stack.

10. The electrochemical reactor according to claim 1, wherein the dome comprises a support flange, configured to fix the dome to the support, the electrochemical reactor further comprising an insulating spacer positioned between the support flange and the support plate of the support.

11. The electrochemical reactor according to claim 10, wherein the dome, the insulating spacer and the support plate are configured, so as to be fixed together in contact by a mechanical device comprising at least one through clamping screw.

12. The electrochemical reactor according to claim 11, wherein the mechanical device comprises at least one insulating sleeve, the at least one insulating sleeve being configured to insulate the at least one through clamping screw.

13. The electrochemical reactor according to claim 1, wherein the operating temperature (Tₒₚ) is greater than 650° C.

14. The electrochemical reactor according to claim 1, wherein the electrochemical reactor comprises heating blocks, the heating blocks being positioned in contact with an external surface of the dome.

15. The electrochemical reactor according to claim 1, comprising a stack, the stack comprising:
an upper plate having a first upper face the first upper face being configured to be the first face of the stack
a superimposition of at least one electrochemical cell and of at least one bipolar plate, positioned along a stacking direction E,
a lower plate having a second lower face, the second lower face being configured to be the second face of the stack.

16. The electrochemical reactor according to claim 15, wherein the support is made of a material identical to the material of the upper plate and of the lower plate.

17. A method for pressurising an electrochemical reactor according to claim 1, wherein the method comprises:
a positioning of the stack on the support,
a positioning and a fixing of the dome on the support, so as to surround the stack,
a filling of the dome with the glass frit through an opening,
a fixing of a stopper in the opening, so as to make the internal volume (Vᵢₙₜ) of the dome hermetic,
an increasing of the temperature in the electrochemical reactor, so as to reach the operating temperature (Tₒₚ),
a pressurising of the reactor up to a clamping pressure (Pₛ) by the pressurising module.
